(19) United States
(12) Patent Application Publication
(10) Pub. No.: US 2026/0045621 A1
(43) Pub. Date: Feb. 12, 2026

(54) APPARATUS AND METHOD FOR MOUNTING SECONDARY BATTERY AND FIXING MEMBER

(71) Applicant: Samsung SDI Co., Ltd., Yongin-si (KR)

(72) Inventor: Youngjun Kim, Yongin-si (KR)

(73) Assignee: Samsung SDI Co., Ltd., Yongin-si (KR)

(21) Appl. No.: 19/247,543

(22) Filed: Jun. 24, 2025

(30) Foreign Application Priority Data
Aug. 12, 2024 (KR) 10-2024-0107596

(51) Int. Cl. H01M 50/264; H01M 10/0525; H01M 50/105; H01M 50/202; H01M 50/244

(52) U.S. Cl. CPC H01M 50/264; H01M 50/202; H01M 50/244; H01M 10/0525; H01M 50/105

(57) ABSTRACT

Aspects of the technology provide an apparatus and method for mounting a battery on a battery mounting portion of a product and a fixing member used therein, and is directed to improving a method of mounting a battery in a product so that the battery can be easily separated after mounting. The apparatus for mounting a battery includes a fixing member placed on a side residual portion of a battery that is positioned in a battery mounting portion of a product on which the battery comprising the side residual portion is mounted, and a fastening member fixing the fixing member to the battery mounting portion of the product, wherein the fixing member comprises a pressurizing part configured to pressurize and restrain at least a part of the side residual portion of the battery.

### CROSS-REFERENCE TO RELATED APPLICATIONS

This present application claims priority to and the benefit under 35 U.S. C. § 119(a)-(d) of Korean Patent Application No. 10-2024-0107596, filed on Aug. 12, 2024, in the Korean Intellectual Property Office, the entire disclosure of which is incorporated herein by reference.

### FIELD

The present disclosure relates to an apparatus and method for mounting a battery on a battery mounting portion of a product and a fixing member used therein.

### BACKGROUND

Batteries include primary batteries that are not rechargeable and secondary batteries that can be charged and discharged. Low-capacity batteries may be used in portable small electronic devices such as smartphones, feature phones, laptop computers, digital cameras, and camcorders, whereas large-capacity batteries are widely used as power sources for driving motors in hybrid vehicles, electric vehicles, and the like as well as for power storage. A battery includes an electrode assembly formed of a positive electrode and a negative electrode, an exterior material such as a case or can for accommodating the electrode assembly, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure is directed to improving a method of mounting a battery in a product so that the battery can be easily separated after mounting.

According to an aspect of the present disclosure, there is provided an apparatus for mounting a battery, which includes a fixing member placed on a side residual portion of the battery, the battery being positioned in a battery mounting portion of a product on which the battery comprising the side residual portion is mounted, and a fastening member fixing the fixing member to the battery mounting portion of the product, wherein the fixing member comprises a pressurizing part configured to pressurize and restrain at least a part of the side residual portion of the battery.

In some embodiments, the battery comprising the side residual portion comprises a pouch-type battery comprising a sealing part.

In some embodiments, the pressurizing part of the fixing member has a transverse width that is greater than a distance in which the side residual portion protrudes from the battery.

In some embodiments, the fastening member comprises a screw or a bolt, and the pressurizing part of the fixing member comprises a through-hole through which the fastening member passes; and the through-hole is positioned further outward than an outer periphery of the side residual portion of the battery.

In some embodiments, the fixing member further comprises a sidewall supporting a side surface of the battery.

In some embodiments, the fixing member further comprises: a sidewall supporting a side surface of the battery; and an upper portion covering at least a portion of an upper surface of the battery.

In some embodiments, at least a part of the upper portion of the fixing member is made of a transparent material.

In some embodiments, the upper portion of the fixing member comprises a through window.

In some embodiments, the apparatus further comprises an insulating sheet interposed between the side residual portion of the battery and the pressurizing part of the fixing member

According to another aspect of the present disclosure, there is provided a battery fixing member including a pressurizing part configured to pressurize and restrain at least a part of a side residual portion of a battery positioned in a battery mounting portion of a product on which the battery including the side residual portion is mounted, and a through-hole through which a fastening member fixing the pressurizing part to the battery mounting portion of the product passes.

In some embodiments, the pressurizing part is formed in one of a sheet shape, a plate shape, or a quadrangular rod shape.

In some embodiments, the pressurizing part has a transverse width that is greater than a distance in which the side residual portion protrudes from the battery.

In some embodiments, the through-hole is positioned further outward than an outer periphery of the side residual portion.

In some embodiments, the battery fixing member further comprises a sidewall supporting a side surface of the battery.

In some embodiments, the battery fixing member further comprises a sidewall supporting a side surface of the battery; and an upper portion covering at least a portion of an upper surface of the battery.

In some embodiments, at least a part of the upper portion is made of a transparent material.

In some embodiments, the upper portion comprises a through window.

According to still another aspect of the present disclosure, there is provided a method of mounting a battery, which includes positioning the battery on a battery mounting portion of a product on which the battery is mounted, and the battery comprising a side residual portion, positioning a fixing member on the side residual portion of the battery, and fixing the fixing member to the battery mounting portion of the product using a fastening member so that the fixing member pressurizes and restrains at least a part of the side residual portion of the battery.

In some embodiments, the positioning of the fixing member on the side residual portion of the battery comprises positioning the fixing member on the side residual portion on each of both sides of the battery.

In some embodiments, the positioning of the fixing member on the side residual portion of the battery comprises interposing an insulating sheet between the side residual portion of the battery and the pressurizing part of the fixing member.

Features and aspects of the present disclosure is not limited to the above, and other features and aspects not specifically mentioned herein, and aspects of the present disclosure that would address such problems, will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic diagram illustrating an electrode assembly of a battery;

FIG. 2 is a schematic diagram illustrating a pouch-type battery;

FIG. 3 is an external view of the pouch-type battery that shows a state in which sealing parts (21) are sealed and then turned upside down to bond upper and lower portions of a pouch (20) shown in FIG. 2;

FIG. 4 is a diagram for describing an apparatus for mounting a battery according to some embodiments of the present disclosure;

FIG. 5 is a diagram illustrating a state in which pressurizing parts (24) of fixing members (100) are placed on the sealing parts (21) of a pouch-type battery (200) and fastened to a battery mounting portion (300) of a product using fastening members (28);

FIG. 6 is a cross-sectional view along line A-A′ of FIG. 5;

FIG. 7 is a diagram illustrating fixing members (100) of an apparatus for mounting a battery according to some other embodiments of the present disclosure;

FIG. 8 is a front view of FIG. 7 that shows a pouch-type battery (200) mounted on a product using fixing members (100);

FIG. 9 is a diagram illustrating a fixing member (100) of an apparatus for mounting a battery according to some other embodiments of the present disclosure;

FIG. 10 is a front view of FIG. 9 that shows a pouch-type battery (200) mounted on a product using the fixing member (100);

FIG. 11 is a diagram illustrating a fixing member (100) of an apparatus for mounting a battery according to some other embodiments of the present disclosure;

FIG. 12 is a front view of FIG. 11;

FIG. 13 is a diagram illustrating a fixing member (100) according to some other embodiments of the present disclosure;

FIG. 14 is a diagram illustrating fixing members (100a, 100b) according to some other embodiments of the present disclosure;

FIG. 15 is a diagram illustrating fixing members (100c, 100d) according to some other embodiments of the present disclosure;

FIG. 16 is a front view of FIG. 15; and

FIG. 17 is a diagram illustrating an example applicable to the above-described embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, ”at least one of A, B or C,“′ ” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.“

Throughout the specification, if “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

Batteries embedded in products such as mobile phones, tablet personal computers (PCs), and other electrical devices can be attached to battery mounting portions of products using double-sided tape. Once a battery is attached with double-sided tape, it is not easy to separate the battery, and when the battery is forcibly pulled with a strong force for separation, an exterior material of the battery may be ruptured or the electrode terminals may be destroyed, which may cause safety issues and may also cause environmental problems as the battery cannot be recycled. Recently, international standards have been established that require batteries to be easily separable from products.

Meanwhile, a pouch-type battery, which is one type of battery, is manufactured by accommodating an electrode assembly in a pouch, injecting an electrolyte, sealing side portions of the pouch, and folding sealing parts.

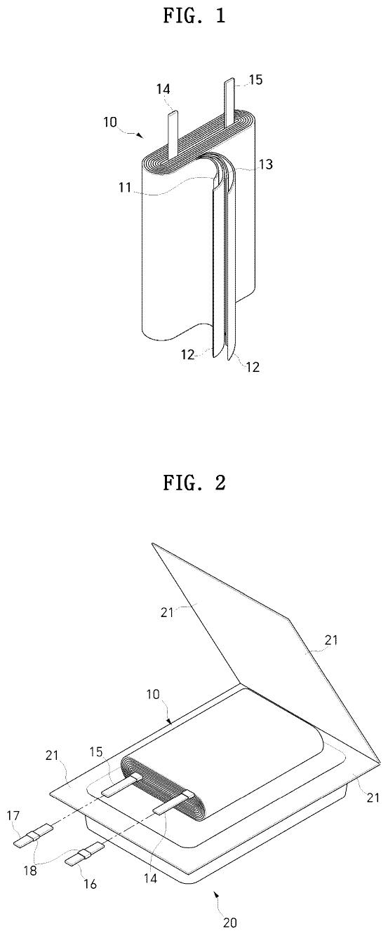

FIG. 1 is a schematic diagram illustrating an example of an electrode assembly of a battery.

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction (e.g., the y direction) of the case 51. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate 11 of the electrode assembly may act as a negative electrode, and the second electrode plate 13 may act as a positive electrode. Of course, the reverse is also possible, in some embodiments, where the first electrode plate 11 acts as a positive electrode and the second electrode plate 13 acts as a negative electrode.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal (not shown). In some embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to an external second terminal (not shown). In some embodiments, the second electrode tab 15 may be formed by being cut in advance to protrude to the other side (e.g., the opposite side relative to the first electrode tab 14) of the electrode assembly 10 when the second electrode plate 13 is manufactured, or the second electrode plate 13 may protrude to the other side of the electrode assembly more than (e.g., farther than or beyond) the separator 12 without being separately cut. In some embodiments, the first electrode tab 14 may be located on the left side of the electrode assembly 10, and the second electrode tab 15 may be located on the right side of the electrode assembly 10. In other embodiments, the first electrode tab 14 and the second electrode tab 15 may be located on one side of the electrode assembly 10 in the same direction.

Here, for convenience of description, the left and right sides are defined according to the electrode assembly 10 as oriented in FIG. 1, and the positions thereof may change when the secondary battery is rotated left and right or up and down.

The separator 12 prevents a short circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

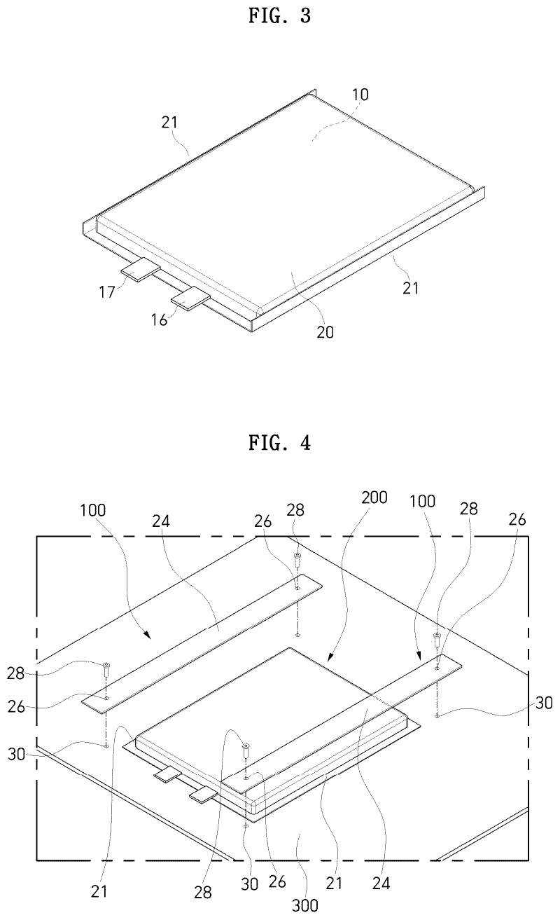

In some embodiments, the electrode assembly 10 may be accommodated in the case (not shown) along with an electrolyte. In the case of a pouch-type secondary battery, an electrode assembly 10 may be accommodated in a pouch made of flexible material in the form illustrated in FIG. 2. In the case of a cylindrical or prismatic secondary battery, an electrode assembly 10 may be accommodated in a cylindrical or prismatic metal casing in the form illustrated in FIGS. 3 and 4.

Examples of material that may be usable for the secondary battery according to the present disclosure is described herein.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O2 (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide. The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ(0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle. The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included. As the negative electrode current collector, a material selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

FIG. 2 is a schematic diagram illustrating a pouch-type battery.

The pouch-type secondary battery includes an electrode assembly 10 and a pouch 20 that accommodates the electrode assembly 10.

The electrode assembly 10 is the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other with the electrode assembly 10 accommodated therein, in which case the sealing may be achieved with the tab film 18 interposed between the sealing parts 21. The sealing parts 21 of the pouch 20 may each be made of a thermal fusion material that generally has weak adhesion to metal. Thus, the sealing parts 21 may be fused to the pouch 20 by interposing the thin tab film 18 between the sealing parts 21.

FIG. 3 is an external view of the pouch-type battery that shows a state in which sealing parts 21 are sealed and then turned upside down to bond upper and lower portions of a pouch 20 shown in FIG. 2.

The sealing parts 21 may be folded to be brought into contact with side surfaces of a battery body and finished. As described above, the process of folding the sealing parts 21 to the side surfaces of the pouch 20 is referred to as side folding.

A first terminal lead 16 and a second terminal lead 17, which are exposed to the outside of the pouch 20, may be connected to a circuit board or electrical part of a product in which the battery is used (e.g., an electric device such as a mobile phone, a tablet, or an electric fan).

Conventionally, in order to embed a battery in a product, double-sided tape may be used to attach the battery to an inside of the product. In this way, since the battery is attached with double-sided tape, it is not easy to separate the battery later, and there may be a safety risk when the battery is forcibly separated.

FIG. 4 is a diagram for describing an apparatus for mounting a battery according to some embodiments of the present disclosure that shows fixing members 100 for mounting a pouch-type battery 200 on a battery mounting portion 300 of a product. The sealing parts 21 of the pouch-type battery 200 may be placed in the battery mounting portion 300 of the product in an unfolded state, and the fixing members 100 may be placed on the sealing parts 21 of the pouch-type battery 200 and fixed using fastening members 28 such as screws. Here, the fixing member 100 may include a pressurizing part 24 for pressurizing the sealing part 21 of the pouch-type battery 200 and a through-hole 26 through which the fastening member 28 passes.

The fastening member 28 is not limited to a screw, but bolts, rivets, clamps, clips, and the like may be used.

The pressurizing part 24 of the fixing member 100 may be in the form of a sheet or plate, but the present disclosure is not limited thereto. For example, the pressurizing part 24 may be formed in the shape of a quadrangular bar.

The pressurizing part 24 may pressurize and restrain at least a portion of the sealing part of the pouch-type battery. That is, although FIG. 4 shows that the pressurizing part 24 of the fixing member 100 covers and pressurizes the entire sealing part 21 of the pouch-type battery 200, in some other embodiments, the pressurizing part 24 may cover and pressurize a portion of the sealing part 21 (for example, see pressurizing parts 24a and 24b of FIG. 14).

The battery mounting portion 300 of the product may be provided with a fastening hole 30 to which the fastening member 28 passing through the through-hole 26 of the pressurizing part 24 is fastened. The fastening hole 30 may be formed in advance to allow the insertion of the fastening member 28, such as a screw or bolt, or may be forcibly formed when the pressurizing part 24 is fixed by the fastening member 28. The through-hole 26 of the pressurizing part 24 may be formed at a position further outward than an outer periphery of the sealing part 21 to prevent the sealing part 21 of the pouch-type battery 200 from being damaged. When a clip or clamp is used as the fastening member instead of a screw, a bolt, or a rivet, the through-hole 26 may not be necessary in the pressurizing part 24.

The fixing member 100 including the pressurizing part 24 may be made of a metal or non-metal (e.g., a synthetic resin, wood, laminated paper, etc.) with rigidity necessary for fixing the pouch-type battery 200. In addition, the metal or non-metal material may have an insulating property, but the present disclosure is not limited thereto.

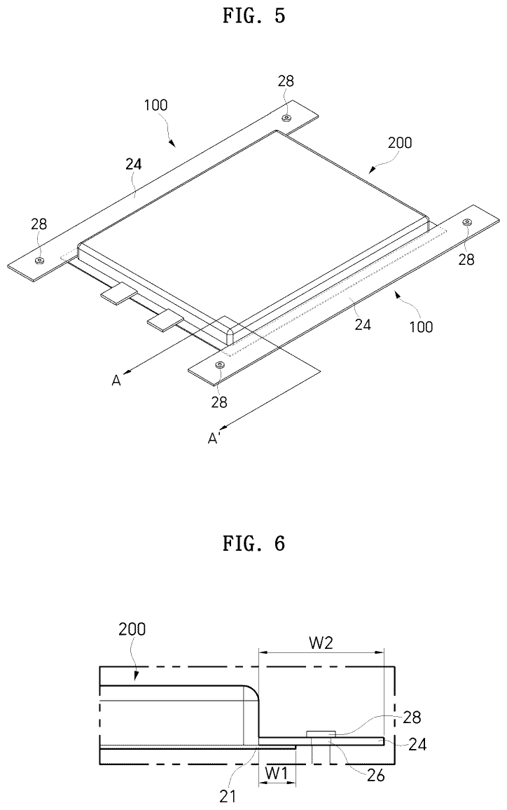

FIG. 5 is a diagram illustrating a state in which pressurizing parts 24 of fixing members 100 are placed on the sealing parts 21 of a pouch-type battery 200 and fastened to a battery mounting portion 300 of a product using fastening members 28.

Since the pouch-type battery 200 is not attached to the product using double-sided tape or the like, the battery 200 may be easily separated from the mounting portion 300 of the product by unfastening the fastening member 28. A risk factor due to battery damage may be eliminated, a separated battery may be recycled, and an interior of the product may remain in a clean state after the separation.

FIG. 6 is a cross-sectional view along line A-A′ of FIG. 5.

As shown in FIG. 6, a width w2 of the pressurizing part 24 of the fixing member 100 is greater than a transverse width of the sealing part 21 of the pouch-type battery 200, that is, a protruding distance w1 from the side surface. In the case of FIG. 6, since the entire surface of the sealing part 21 is covered by the pressurizing part 24, there is no probability of damage to the sealing part 21, and thus a sealing state of the pouch-type battery 200 is not affected.

FIG. 6 also shows that the through-hole 26, which may be necessary when a screw, a bolt, a rivet, or the like is used as the fastening member 28, is positioned to avoid the sealing part 21.

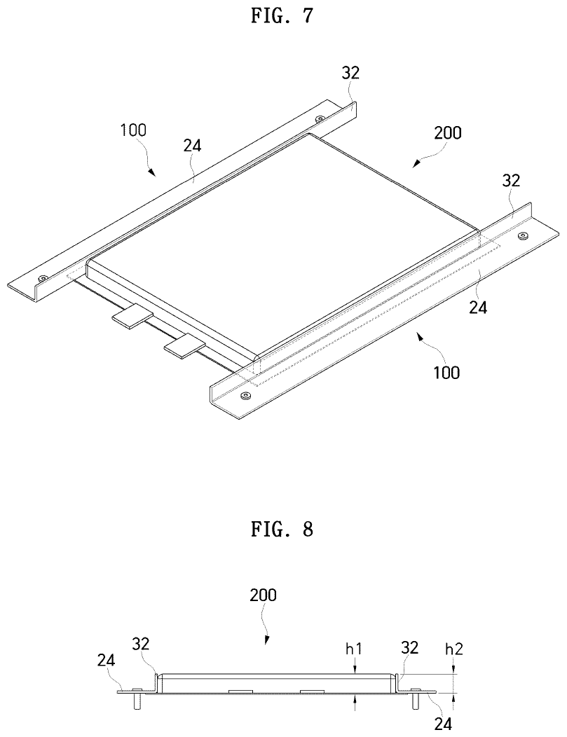

FIG. 7 is a diagram illustrating a fixing member 100 of an apparatus for mounting a battery according to some other embodiments of the present disclosure.

The fixing member 100 according to the embodiment may additionally include a sidewall 32 for supporting a side surface of the pouch-type battery 200 in addition to the pressurizing part 24 shown in FIGS. 4 and 5.

The pressurizing part 24 of the fixing member 100 may press and fix the sealing part 21 of the pouch-type battery 200 by pressing the sealing part 21 from top to bottom, and the sidewall 32 may support a side surface of a body of the battery 200 to prevent horizontal shaking of the battery 200, thereby further increasing mounting rigidity. As described herein, the fixing member 100 including the pressurizing part 24 and the sidewall 32 may be made of a metal or non-metal (e.g., a synthetic resin, wood, laminated paper, etc.). In addition, the metal or non-metal material may have an insulating property, but the present disclosure is not limited thereto.

FIG. 8 is a front view of FIG. 7 that shows the pouch-type battery 200 mounted on a product using the fixing member 100. In FIG. 8, a height h1 of the battery 200 may be equal to or different from a height h2 of the sidewall 32. For example, h1>h2 or h1=h2 may be employed when the sidewall 32 should not interfere with other structures positioned on an upper surface of the battery 200, and h1<h2 may be intentionally employed such that the sidewall 32 serves to prevent other structures from coming into contact with the upper surface of the battery 200.

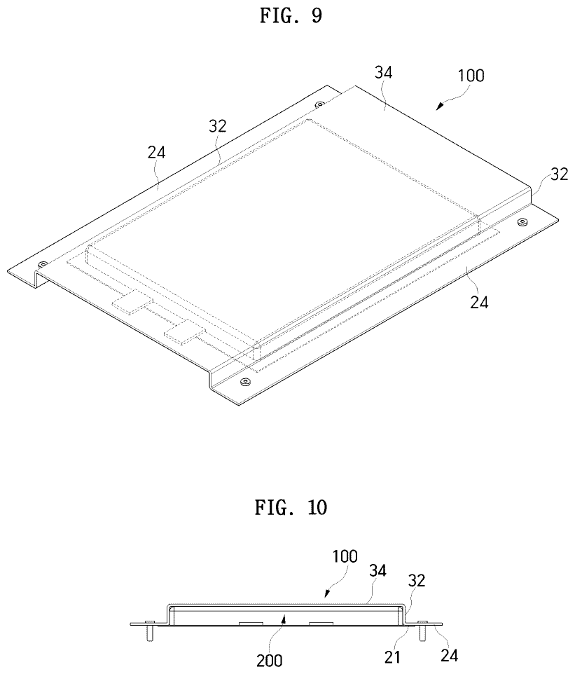

FIG. 9 is a diagram illustrating a fixing member 100 of an apparatus for mounting a battery according to some other embodiments of the present disclosure. FIG. 10 is a front view of FIG. 9 that shows a pouch-type battery 200 mounted on a product using the fixing member 100.

The fixing member 100 according to the embodiment may additionally include an upper portion 34 for covering an upper surface of the pouch-type battery 200 in addition to the pressurizing part 24 and the sidewall 32 shown in FIG. 9.

Here, the fixing member 100 may protect the upper surface of the pouch-type battery 200 and may block physical, electrical, or chemical influences applied to the battery 200 by other structures within the product.

As described herein, the fixing member 100 including the pressurizing part 24, the sidewall 32, and the upper portion 34 may be made of a metal or non-metal (e.g., a synthetic resin, wood, laminated paper, etc.). In addition, the metal or non-metal material may have an insulating property, but the present disclosure is not limited thereto.

In addition, in FIG. 9, the upper portion 34 of the fixing member 100 may be made of an opaque material so that the pouch-type battery 200 below the upper portion 34 is not visible.

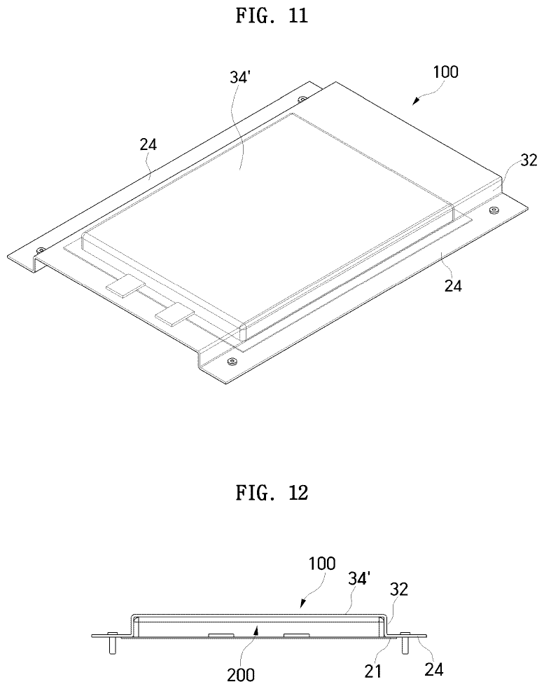

FIG. 11 is a diagram illustrating a fixing member 100 of an apparatus for mounting a battery according to some other embodiments of the present disclosure. FIG. 12 is a front view of FIG. 11 that shows a pouch-type battery 200 mounted on a product using the fixing member 100.

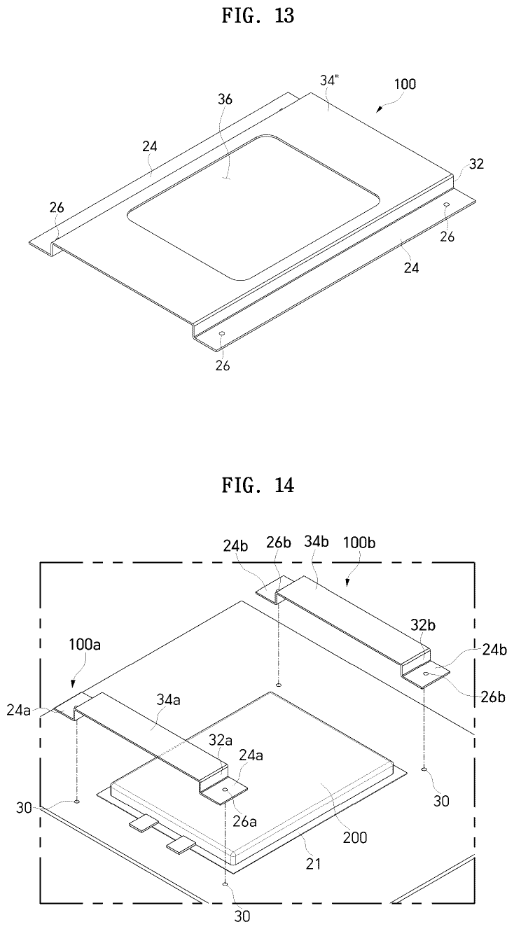

The fixing member 100 according to the embodiment is similar to that shown in FIG. 9, and differs in that all or a portion of an upper portion 34′ of the fixing member 100 may be made of a transparent material so that the pouch-type battery 200 below the upper portion 34′ is visible and information indicated on the battery may be checked. FIG. 13 is a diagram illustrating a fixing member 100 according to some other embodiments of the present disclosure. Instead of manufacturing at least the upper portion 34′ of the fixing member 100 with a transparent material as in the embodiment of FIG. 11, a through window 36 may be formed on the upper surface 34″ as in FIG. 13.

In the embodiment, the upper surface of the pouch-type battery 200 may be checked without the upper portion being manufactured with a transparent material.

FIG. 14 shows a fixing member according to some embodiments of the present disclosure and shows fixing members 100a and 100b with a configuration in which a plurality of pressurizing parts 24a and 24b pressurize portions of the sealing parts 21 instead of the structure in which the pressurizing part 24 entirely covers the sealing part 21 of the pouch-type battery 20 like the embodiment of FIG. 9 or 11.

The fixing members 100a and 100b of the embodiment may expose the upper surface of the battery 200 without the through window 36 as in FIG. 13 and protect the upper portion and a part of an outer periphery of the battery 200.

In the embodiment of FIG. 14, the two fixing members 100a and 100b are shown, but in other embodiments, more fixing members may be possible.

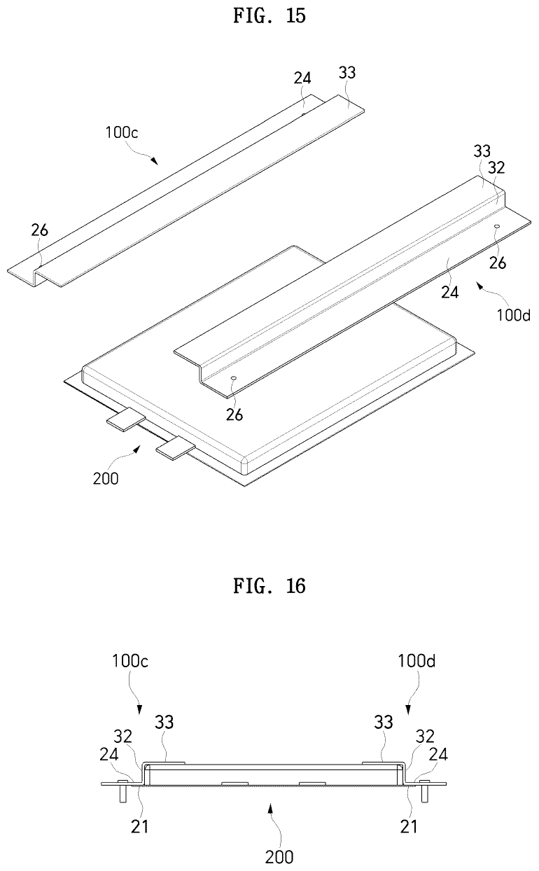

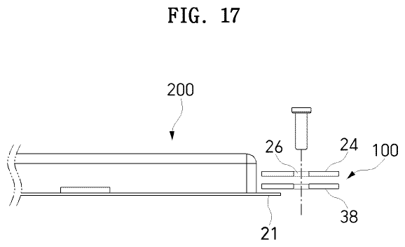

FIG. 15 shows fixing members 100c and 100d according to some embodiments of the technology described herein and shows that, as in the previous embodiments of FIGS. 9 to 11, the fixing member 100 is modified to include upper portions 34, 34′, and 34″ for entirely covering the sealing part 21 of the pouch-type battery 200. FIG. 16 is a front view of FIG. 15.

The fixing members 100c and 100d according to the embodiment may include sidewalls 32 connected to the pressurizing parts 24 for pressurizing the sealing parts 21 on both sides of the pouch-type battery 200, and upper portions 33 connected to the sidewalls 32 and covering portions of the upper surface of the pouch-type battery 200. Thus, even without forming the wide upper portions 34′ and 34″ to expose the upper surface of the battery 200 as in FIG. 11 or FIG. 13, information indicated on the upper surface of the battery 200 may be exposed, and side surfaces of the battery 200 and a portion of the upper surface connected to the side surfaces may be protected or supported.

FIG. 17 is a diagram illustrating an example applicable to the above-described embodiments. In order to insulate the sealing part 21 of the pouch-type battery 200, an insulating sheet 38 may be positioned between the pressurizing part 24 of the fixing member 100 and the sealing part 21 of the battery 200. The insulating sheet 38 may be particularly useful when the pressurizing part 24 of the fixing member 100 is made of a conductive material such as a metal, but the present disclosure is not limited thereto. The apparatuses for mounting a battery and the fixing members used therein according to the various embodiments of the present disclosure described herein may be applied to other types of batteries in addition to the pouch-type batteries. For example, side residual portions similar to the above-described sealing parts may be formed using an outer tape used to insulate or decorate an outer surface of a prismatic or cylindrical battery, and fixing members similar to the above-described embodiments, including pressurizing parts for pressurizing the side residual portions, may be manufactured so that the prismatic or cylindrical battery can be mounted on a product.

A method of mounting a battery using the above-described apparatus for mounting a battery will be described. The following description of the method will not be limited to the pouch-type battery including the sealing parts described in the above embodiments, and a method of mounting a battery having a prismatic or cylindrical shape will be described.

The method of mounting a battery according to some embodiments of the present disclosure may include positioning a battery on a battery mounting portion of a product on which the battery including side residual portions is mounted, positioning fixing members on the side residual portions of the battery, and fixing the fixing members to the battery mounting portions using a fastening member so that the fixing members pressurize and restrain at least a part of the side residual portions of the battery.

In some embodiments, the positioning of the fixing members on the side residual portions of the battery may include positioning the fixing members on each of the side residual portions of the battery.

In some embodiments, the positioning of the fixing members on the side residual portions of the battery may include interposing an insulating sheet between the side residual portion of the battery and the pressurizing part of the fixing member.

Here, the operations, for example, the positioning of the battery on the battery mounting portion, the positioning of the fixing members on the side residual portions of the battery, the fixing of the fixing members using the fastening members, and the interposing of the insulating sheet, may be performed by automated equipment, such as a robot arm, but the present disclosure is not limited thereto.

According to an apparatus and method for mounting a battery of the present disclosure, a battery can be easily separated from a product after the battery is mounted on the product so that problems of stability and negative impacts on the environment can be solved, and international standards requiring easy separation of a battery pack from the product can be satisfied.

In addition, a pouch-type battery can be actively used in a product in which an expensive metal can battery is conventionally used for easy battery separation so that benefits such as cost reduction and product weight reduction can be obtained.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. An apparatus for mounting a battery, comprising:
a fixing member placed on a side residual portion of the battery, the battery being positioned in a battery mounting portion of a product on which the battery comprising the side residual portion is mounted; and
a fastening member fixing the fixing member to the battery mounting portion of the product,
wherein the fixing member comprises a pressurizing part configured to pressurize and restrain at least a part of the side residual portion of the battery.

2. The apparatus as claimed in claim 1, wherein the battery comprising the side residual portion comprises a pouch-type battery comprising a sealing part.

3. The apparatus as claimed in claim 1, wherein the pressurizing part of the fixing member has a transverse width that is greater than a distance in which the side residual portion protrudes from the battery.

4. The apparatus as claimed in claim 1, wherein:
the fastening member comprises a screw or a bolt, and the pressurizing part of the fixing member comprises a through-hole through which the fastening member passes; and
the through-hole is positioned further outward than an outer periphery of the side residual portion of the battery.

5. The apparatus as claimed in claim 1, wherein the fixing member further comprises a sidewall supporting a side surface of the battery.

6. The apparatus as claimed in claim 1, wherein the fixing member further comprises:
a sidewall supporting a side surface of the battery; and
an upper portion covering at least a portion of an upper surface of the battery.

7. The apparatus as claimed in claim 6, wherein at least a part of the upper portion of the fixing member is made of a transparent material.

8. The apparatus as claimed in claim 6, wherein the upper portion of the fixing member comprises a through window.

9. The apparatus as claimed in claim 1, further comprising an insulating sheet interposed between the side residual portion of the battery and the pressurizing part of the fixing member 10. A battery fixing member comprising:
a pressurizing part configured to pressurize and restrain at least a part of a side residual portion of a battery positioned in a battery mounting portion of a product on which the battery comprising the side residual portion is mounted; and
a through-hole through which a fastening member fixing the pressurizing part to the battery mounting portion of the product passes.

11. The battery fixing member as claimed in claim 10, wherein the pressurizing part is formed in one of a sheet shape, a plate shape, or a quadrangular rod shape.

12. The battery fixing member as claimed in claim 10, wherein the pressurizing part has a transverse width that is greater than a distance in which the side residual portion protrudes from the battery.

13. The battery fixing member as claimed in claim 10, wherein the through-hole is positioned further outward than an outer periphery of the side residual portion.

14. The battery fixing member as claimed in claim 10, further comprising a sidewall supporting a side surface of the battery.

15. The battery fixing member as claimed in claim 10, further comprising:
a sidewall supporting a side surface of the battery; and
an upper portion covering at least a portion of an upper surface of the battery.

16. The battery fixing member as claimed in claim 15, wherein at least a part of the upper portion is made of a transparent material.

17. The battery fixing member as claimed in claim 15, wherein the upper portion comprises a through window.

18. A method of mounting a battery, comprising:
positioning the battery on a battery mounting portion of a product on which the battery is mounted, the battery comprising a side residual portion;
positioning a fixing member on the side residual portion of the battery; and
fixing the fixing member to the battery mounting portion of the product using a fastening member so that the fixing member pressurizes and restrains at least a part of the side residual portion of the battery.

19. The battery fixing member as claimed in claim 18, wherein the positioning of the fixing member on the side residual portion of the battery comprises positioning the fixing member on the side residual portion on each of both sides of the battery.

20. The battery fixing member as claimed in claim 18, wherein the positioning of the fixing member on the side residual portion of the battery comprises interposing an insulating sheet between the side residual portion of the battery and the pressurizing part of the fixing member.
